(19) United States
(12) Patent Application Publication
(10) Pub. No.: US 2022/0176746 A1
(43) Pub. Date: Jun. 9, 2022

(54) TIRE WITH WORKING LAYERS COMPRISING AN OPTIMIZED ARCHITECTURE AND TREAD DESIGN

(71) Applicant: COMPAGNIE GENERALE DES ETABLISSEMENTS MICHELIN, Clermont-Ferrand (FR)

(72) Inventors: VINCENT TOURNEUX, Clermont-Ferrand (FR); DANIEL FABING, Clermont-Ferrand (FR); PATRICE FRAYSSE, Clermont-Ferrand (FR); MATHIEU ALBOUY, Clermont-Ferrand (FR); FRANCOIS CHAMBRIARD, Clermont-Ferrand (FR)

(21) Appl. No.: 17/599,004

(22) PCT Filed: Mar. 19, 2020
(86) PCT No.: PCT/EP2020/057594

§ 371 Date: Sep. 28, 2021

(30) Foreign Application Priority Data
Mar. 28, 2019 (FR) 1903217

(51) Int. Cl. B60C 9/28; B60C 11/13

(52) U.S. Cl. CPC B60C 9/28; B60C 2011/0353; B60C 11/13

(57) ABSTRACT

A tire comprises, in the central part of its crown, at least one undulation (51) with a radial amplitude A of the radially outermost crown layer, circumferential furrows (24) and open grooves (25), some of these grooves being radially on the outside of the undulation (51). At least 50% of these grooves (25) are said to be adapted to the undulation. An open groove adapted to the undulation which it is radially on the outside of is such that the intersection points Ps of the bottom curve Cf of said groove and of the furrows (24) are at a distance from the radially outermost point Pext of said bottom curve Cf by a radial distance d2 at least equal to one third of the radial amplitude (A/3) of the undulation (51) and such that the curve Cf increases radially from the intersection points Ps to the point Pext.

The present invention relates to a tyre intended to be fitted to a vehicle, and more particularly to the crown of such a tyre.

Since a tyre has a geometry exhibiting symmetry of revolution about an axis of rotation, the geometry of the tyre is generally described in a meridian plane containing the axis of rotation of the tyre. For a given meridian plane, the radial, axial and circumferential directions denote the directions perpendicular to the axis of rotation of the tyre, parallel to the axis of rotation of the tyre and perpendicular to the meridian plane, respectively. The median circumferential plane referred to as the equatorial plane divides the tyre into two substantially symmetrical half-torus shapes, it being possible for the tyre to exhibit tread or architecture asymmetries that are connected with the manufacturing precision or with the sizing.

In the following text, the expressions “radially on the inside of” and “radially on the outside of” mean “closer to the axis of rotation of the tyre, in the radial direction, than” and “further away from the axis of rotation of the tyre, in the radial direction, than”, respectively. The expressions “axially on the inside of” and “axially on the outside of” mean “closer to the equatorial plane, in the axial direction, than” and “further away from the equatorial plane, in the axial direction, than”, respectively. A “radial distance” is a distance with respect to the axis of rotation of the tyre and an “axial distance” is a distance with respect to the equatorial plane of the tyre. A “radial thickness” is measured in the radial direction and an “axial width” is measured in the axial direction.

In the following text, the expression “vertically beneath” means “for each meridian, radially on the inside within the boundaries of the axial coordinates delimited by”. Thus, “the points of a working layer that are vertically beneath a groove” denote, for each meridian, the collection of points in the working layer that are radially on the inside of the groove within the boundaries of the axial coordinates delimited by the groove.

A tyre comprises a crown comprising a tread that is intended to come into contact with the ground via a tread surface, two beads that are intended to come into contact with a rim, and two sidewalls that connect the crown to the beads. Furthermore, a tyre comprises a carcass reinforcement comprising at least one carcass layer that is radially on the inside of the crown and connects the two beads.

The crown comprises at least one crown reinforcement radially on the inside of the tread. The crown reinforcement comprises at least one working reinforcement comprising at least one working layer made up of mutually parallel reinforcing elements that form an angle of between 15° and 50° with the circumferential direction. The crown reinforcement may also comprise a hoop reinforcement comprising at least one hooping layer made up of reinforcing elements that form an angle of between 0° and 10° with the circumferential direction, the hoop reinforcement usually, although not necessarily, being radially on the outside of the working layers.

For any layer of reinforcing elements of a crown, working or other reinforcement, a continuous surface, referred to as the radially outer surface (ROS) of said layer, passes through the radially outermost points of each reinforcing element, of each meridian. For any layer of reinforcing elements of a crown, working or other reinforcement, a continuous surface, referred to as the radially inner surface (RIS) of said layer, passes through the radially innermost points of each reinforcing element, of each meridian. The radial distances between a layer of reinforcing elements and any other point are measured from one or the other of these surfaces and in such a way as not to incorporate the radial thickness of said layer. If the other measurement point is radially on the outside of the layer of reinforcing elements, the radial distance is measured from the radially outer surface ROS to this point and, respectively, from the radially interior surface RIS to the other measurement point if the latter is radially on the inside of the layer of reinforcing elements. This makes it possible to consider radial distances that are coherent from one meridian to the other, without it being necessary to take into account possible local variations associated with the shapes of the sections of the reinforcing elements of the layers.

In order to obtain good grip on wet ground, cuts are made in the tread. A cut denotes either a well, or a groove, or a sipe, or a circumferential furrow, and forms a space opening onto the tread surface.

A groove has, on the tread surface, two characteristic main dimensions: a width W and a length Lo, such that the length Lo is at least equal to twice the width W. A groove is therefore delimited by at least two main lateral faces that determine its length Lo and are connected by a bottom face, the two main lateral faces being at a non-zero distance from one another, referred to as the width W of the groove, sometimes referred to as a sipe. A sipe is a specific groove, the width W of which is small enough for its lateral faces to come into contact when said sipe is in contact with the ground.

An open groove is a groove that opens into a groove that may be a circumferential furrow. A circumferential furrow is a groove with a large width Ws at least equal to 6 mm, locally making an angle at most equal to 45° with the circumferential direction and forming a space that opens onto the entire circumference of the tyre. In many tyre variants, the angle formed by the circumferential furrows with the circumferential direction is constant and zero around the entire circumference. In other variants, certain furrows are continuous series, around the entire circumference, of grooves which make different angles and the continuity of which forms a space that opens onto the entire circumference of the tyre.

The depth of the cut is the maximum radial distance between the tread surface and the bottom of the cut. The maximum value for the depths of the cuts is referred to as the tread pattern depth D.

Depending on their circumferential or transverse dispositions, the grooves and the circumferential furrows determine blocks or ribs of rubber material in the tread. A rib may contain grooves. In complex treads, a rib in the new state may, after wearing down, turn into a series of blocks. The lateral faces of the grooves and of the circumferential furrows are also referred to as the “cliffs” of the blocks or ribs that they delimit.

The bottom surfaces are made up of points connecting the lateral surfaces of the grooves that form angles of between 0 and 70° with the radial direction. The lateral surfaces may contain discontinuities, overhanging parts, where the local angle is not in this range. Nevertheless, those skilled in the art will know how to determine the lateral surfaces and the bottom surface in spite of these discontinuities.

The open bottom surfaces have a bottom curve. The points of the bottom curve that are the most obvious to determine are the common point(s) Ps between the bottom surface of the groove and the, lateral or bottom, surface(s) of the circumferential furrow(s) into which the groove in question opens. The bottom curve corresponds mathematically to the talweg line of the bottom surface, that is to say the radially innermost points of the bottom surface from the two points PS if the groove opens into two circumferential furrows or from the single point PS to the other axial end of the groove in the case of a blind sipe, terminated by a third lateral surface, this end Pe being determined as the radially innermost point of the junction curve between the bottom surface and this third lateral surface of the groove in question.

The bottom curve is determined, for the grooves that form a mean angle at least equal to 15° with the circumferential axis, by all of the radially innermost points of the curves resulting from the intersection of the bottom surface and the circumferential planes passing between the two junction points of the bottom surface and the circumferential furrows PS of the groove or between the two ends PS and Pe of the groove. If there is more than one intersection between one of the planes and the bottom curve, the point considered to be part of the curve will be the most equidistant point from the radially innermost points of the intersection between two lateral faces and the circumferential plane in question.

A tyre needs to meet numerous performance criteria relating to phenomena such as wear, grip on various types of ground, rolling resistance, dynamic behaviour, and noise. These performance criteria sometimes lead to solutions that compromise other criteria. Thus, the documents FR3057810 and FR3057811 disclose tyres in which the crown layers have undulations. These undulations make it possible to increase the transverse stiffness of the coupling between the crown reinforcement and the tread. Depending on the materials chosen for the tread, creating undulations in the crown layer makes it possible to improve the performance of the tyre in terms of behaviour by improving its grip, more particularly its wet-grip, and rolling-resistance performance without altering its wearing and crown-durability performance.

However, this technology has an influence on the wear pattern of the tread. The undulations discussed in the cited documents and in the present invention are such that the points of the undulation are radially on the outside of the points of the crown layer undulating under the groove closest to the point in question. The aim is to reduce the thickness of the tread radially on the outside of the undulation in order to decrease shearing of the rubber compositions of the tread in order to improve the stiffness of the crown of the tyre and thus to improve behaviour and rolling-resistance performance. Depending on the type of rubber compositions in the tread and the performance thereof in terms of hysteresis at 0° and at 60° determining the wet-grip and rolling-resistance performance thereof, it is possible to improve grip and/or rolling resistance.

In this configuration, the undulations of the radially outermost crown layer, or of a plurality of crown layers, the distance between these layers being substantially constant over their surface in the central part of the crown, bring about a particular circumferential wear pattern that is more pronounced at the axial edges of the ribs or blocks radially on the outside of an undulation, that is to say close to the cliffs of said ribs or blocks.

Specifically, under the action of the internal pressure of the tyre when inflated, the carcass layer and the crown layers are subjected to axial and circumferential tension, which tends to reduce the radial amplitude of the undulations. This movement of the crown layers also radially moves the rubber compounds radially on the outside of the undulation. The movement is at a minimum in the regions in which the undulation is at a minimum or absent, in particular vertically beneath the circumferential furrows. As a result, for a block or rib radially on the outside of an undulation, the movement of the cliffs of the ribs is less than the movement at the centre of the block or rib. The contact pressure is, as a result, increased in the contact zone close to the cliffs of the substantially longitudinal ribs, generating more wear. This wear is particularly apparent for the lateral faces of the circumferential furrows. It is possible to compensate for this wear by adopting an at least axially domed profile of the blocks and ribs. When the tyre is suitably dimensioned, the doming of the blocks and ribs is retained throughout the lifetime of the tyre.

Since the undulations of the crown layers are present throughout the lifetime of the tyre, this overpressure at the cliffs of the blocks or ribs is continuous throughout the lifetime of the tyre. According to the prior art, the grooves present in a tread, which are open or not open, have a bottom surface, the radially innermost points of which, or bottom curve, are not adapted to the undulations of the crown layers and, as a result, are situated substantially at the same radial distance from the axis of rotation of the tyre. Tyre wear, by erosion of the rubber composition(s) of which the tread is made, gradually decreases the tread pattern height.

Since the cliffs of the ribs or blocks wear down more rapidly than the centres thereof, this wear takes place in a domed transverse wear profile. With a bottom curve situated on one and the same radius, the part of an open groove close to the cliff of the rib or block in which it is located therefore erodes more quickly and disappears before the part of said groove at the centre of said groove or block.

When running, in the contact patch, on account of the overpressure, the cliff closes the groove on the side where the groove was open in the new state. This closure of the groove creates a sound wave which increases the level of noise of the running tyre in an identical way to a non-open sipe.

The main objective of the present invention is therefore to improve the noise and wet-grip performance of a tyre, the crown layers of which contain undulations radially on the inside of the central part of the tread and comprising open grooves radially on the outside of the undulations, this improvement being observed when said grooves are still visible but have a shallow depth on account of their wear.

This objective is achieved by a tyre comprising:
a tread intended to come into contact with the ground via a tread surface having an axial width L and comprising a central part of the tread having a width equal to 0.8*L, this central part of the tread comprising at least two circumferential furrows,
a circumferential furrow forming a space that opens onto the tread surface around the entire circumference of the tyre and being delimited by two main lateral faces connected by a bottom face, and having a mean width Ws at least equal to 6 mm and a depth D at least equal to 4 mm,
the central part of the tread comprising grooves forming a space that opens onto the tread surface, forming an angle at least equal to 15° with the circumferential axis, and being delimited by two main lateral faces connected by a bottom face, a groove having a width Wr defined by the mean distance between the two lateral faces, and having a width Wr at least equal to 0.5 mm, at least fifty percent of these grooves being open grooves, namely grooves that open into one or two circumferential furrows,
each open groove comprising a bottom curve Cf formed by all of the radially innermost points of the bottom surface of said groove, each bottom curve comprising at least one point Ps, and at most two, in common with the furrow or the two furrows into which said groove opens, and a radially outermost point Pext,
a carcass layer and a crown reinforcement, radially on the inside of the tread, comprising at least one crown layer, the crown layer(s) being layers of reinforcing elements,
   the crown reinforcement comprising a working reinforcement comprising at least one working layer,
each working layer comprising reinforcing elements which are at least partially made of metal coated in an elastomer material, are mutually parallel and form with the circumferential direction (XX′) of the tyre an oriented angle of which the absolute value is at least equal to 15° and at most equal to 50°,
each crown layer extending radially from a radially inner surface (RIS) to a radially outer surface (ROS),
   the radially outermost crown layer vertically beneath the central part of the tread comprising at least one undulation, referred to as central undulation, with a radial amplitude A,
the portion of the radially outer surface (ROS) of the crown layer of said central undulation is radially on the outside of the points of the radially outermost crown layer vertically beneath the bottom face of the circumferential furrow closest to said undulation,
over at least 10% of the radially outer surface (ROS) of said crown layer vertically beneath the central part of the tread, the radial distance (do) between the radially outer surface (ROS) of the radially outermost crown layer and the tread surface at said undulation is at least 1 mm less than the radial distance (dc) between the radially outer surface (ROS) of the radially outermost crown layer and the tread surface, this being the distance vertically beneath the bottom face of the circumferential furrow closest to the point in question on said surface.
the radial distance (d1) between the radially outer surface (ROS) of the radially outermost crown layer and the bottom face of the circumferential furrows is at most equal to 4 mm,
at least 50% of the open grooves radially on the outside of a central undulation of the radially outermost layer of reinforcing elements being said to be adapted to the central undulation, an open groove that is adapted to the undulation which it is radially on the outside of being such that the intersection point(s) Ps of the bottom curve Cf of said open groove adapted to the undulation and of the circumferential furrow(s) into which said open groove adapted to the undulation opens are at a distance from the radially outermost point Pext of said bottom curve Cf by a radial distance (d2) at least equal to one third of the radial amplitude (A/3) of the central undulation situated vertically beneath said open groove adapted to the undulation, and said curve Cf increases radially from the intersection point(s) Ps to the point Pext.

The grooves discussed in the invention may have a constant or non-constant width. The invention also works with grooves having variable widths, for example having a greater width at the bottom surface in order to create more voids in the contact patch at a level of wear revealing these increased widths, in order to improve grip. In order for the invention to work, it is enough for the bottom curve to be adapted to the undulation. In this way, regardless of the wear, the bottom curve ensures that the groove is open, eliminating the risk of the loss of edge ridges which would reduce grip and the creation of a non-open or blind groove having the consequence of impairing the noise performance compared with the new tyre.

The effect of the invention can be observed throughout the lifetime of the tyre depending on the depth of the grooves radially on the outside of the undulations of the radially outermost layer of the crown reinforcement or of the crown layers. If the groove has a shallow depth, the effect of the invention is observable at the start of wearing of the tyre. If the bottom profile of the groove is close to the radially outermost point of the wear indicator, the effect of the invention is observable at the wear limit of the tyre. If the grooves in question have different depths, the effect can be perceived throughout the lifetime of the tyre.

The radially outermost crown layer needs to have at least one undulation. These undulations have a radial amplitude at least equal to 1 mm, preferably at least equal to 1.5 mm, and preferably at least equal to 2 mm. The greater the radial amplitude of the undulation, the greater the impact on the stiffness of the tyre and the better the performance in terms of rolling resistance, behaviour, and grip associated with this architecture. The greater the radial amplitude of these undulations, the greater the overpressures in the tread surface at the cliffs of the ribs or blocks of the tread and the more it is necessary to dome the ribs or blocks radially on the outside of the undulations and the more it is necessary for the bottom profiles of the grooves to be curved in order to maintain these improvements throughout the service life of the tyre.

It is necessary that the intersection point(s) Ps of the bottom curve Cf of said groove and of the furrow(s) into which said groove opens are at a distance from the radially outermost point Pext of said bottom curve Cf by a radial distance (d2) at least equal to one third of the radial amplitude (A/3) of the undulation situated vertically beneath said groove, and that said curve increases radially from the intersection point(s) Ps to the point Pext.

The expression “increases radially” is understood as meaning that the derivative of the radial distance of the point of the bottom curve from the axis of rotation of the tyre, as a function of the curved abscissa of the point, is at least equal to 0, the curved abscissa having a starting point Ps as its origin and the point Pext as its end, over 90% of the points of the bottom curve, the existence of local irregularities of small radial amplitude, less than 20% of the radial amplitude of the bottom curve, not having a detrimental effect on the invention. If the groove opens into two circumferential furrows and therefore at two points Ps, this property needs to be verified starting from the second point Ps.

Preferably, the intersection point(s) Ps of the bottom curve Cf of said groove and of the furrow(s) into which said groove opens are at a distance from the radially outermost point Pext of said bottom curve Cf by a radial distance (d2) at least equal to half the radial amplitude (A/2) of the central undulation situated vertically beneath said groove, and preferably at most equal to 1.5 times the radial amplitude (1.5*A) of the central undulation situated vertically beneath said groove. For a distance d2 at least equal to A/2, the risk of the wear pattern of the ribs or blocks not providing the anticipated effect decreases and the reliability of the invention increases. For a distance d2 greater than 1.5A, there is a drop in stiffness of the cliff of the rib compared with the centre thereof, this increasing local wear, which should be avoided.

For the invention to work well, it is necessary for the radially outermost crown layer to have undulations. It is preferred for other crown layers to have undulations with the undulations having substantially the same radial amplitude and the same position as the radially outermost crown layer, so as to keep the thickness of the stack of undulating layers constant over the greatest surface area of these crown layers. This makes it possible to obtain maximum effectiveness from the undulations.

Preferably, all the crown layers have undulations, and their undulations are substantially identical in terms of position and of radial amplitude in their portions situated vertically beneath the central part of the tread, give or take manufacturing variations.

It is preferred for at least 90 percent and preferably all of the open grooves radially on the outside of a central undulation of the radially outermost crown layer to be adapted to said central undulations (51), which they are respectively radially on the outside of, of the radially outermost crown layer.

In a conventional architecture comprising a hooping layer, preferably textile, and two working layers comprising metal reinforcing elements, the hooping layer being the radially outermost of the crown layers, it is necessary for this hooping layer to be undulating. The performance in terms of rolling resistance, grip or behaviour is better still if the working layer contiguous with the hooping layer is undulating with undulations having the same radial amplitude and same positions at least partially and, better still, over the entire surface of the hooping layer. These same performance aspects are even better still if the two working layers and the hooping layer are undulating with undulations having the same radial amplitude and the same positions. The invention works even if part of the working layer contiguous with the hooping layer is undulating and coupled over these undulations to the hooping layer and another part which is not coupled.

One condition necessary for the invention to work is that the crown layers be at a limited distance from the tread surface, particularly at the radially outermost point of the undulation. Depending on the desired degree of protection for the radially outermost crown layer, the thickness of rubber compound between the radially outermost crown layer and the bottom of the grooves is at least equal to 0.5 and at most equal to 4 mm. It is not a matter of increasing this thickness of rubber compound, but rather of reducing the distance between the tread surface in the new state and the radially outermost point of the undulation. In fact, a sufficient condition is that the radial distance (do) between the radially outer surface (ROS) of the radially outermost crown layer and the tread surface at the undulation be at least 1 mm less than the radial distance (dc) between the radially outer surface (ROS) of the radially outermost crown layer and the tread surface, this being the distance (dc) vertically beneath the centre of the bottom face of the circumferential furrow closest to the point in question on said surface. This condition ensures a minimum radial amplitude of the undulation of 1 mm, and ensures that the undulation vertically beneath the ribs or blocks is indeed intended to reduce the distance between the radially outermost layer and the tread surface compared with a tyre that has no undulation.

The radial amplitude of each undulation in a crown layer is measured as being the radial distance between the radially outermost point P1 on the radially outer surface (ROS) of said crown layer vertically beneath the block or rib in question and the radially innermost point of the radially outer surface (ROS) of said crown layer vertically beneath the circumferential furrow closest to the point P1. If there are two circumferential furrows equidistant from the radially outermost point P1 of the undulation in question, the point taken into consideration for calculating the radial amplitude will be the one that yields the highest radial-amplitude value. The radial amplitude is measured in a meridian section plane comprising the axis of rotation of the tyre and perpendicular to the circumferential direction of the tyre. If the radial amplitude varies in the circumferential direction, the value retained for the radial amplitude is the highest one.

The undulations in question are undulations referred to as central undulations; they are situated in the central part of the tread, which part is centred on the equatorial plane and has a width of 0.8L, L being the width of the tread surface of the tyre in the new state. The width L is measured with the tyre mounted on a nominal rim and inflated to nominal pressure. The zones of non-coupling between the crown layers in the axially outermost parts of the tyre or shoulder region, outside of the central part, the objective of said zones being solely to uncouple the crown layers at their ends in order to avoid cracking of the compounds in this region, are not considered to be undulations.

Motorcycle tyres are not generally disposed at a substantially constant radius. However, for these tyres, the layers of material in the crown are disposed in a continuous, convex curve. The invention may also be applied to these tyres, the undulations creating regions of greater concavity and convexity about the continuous curve of the tyre for a motorcycle according to the prior art.

It would appear that a 10% undulation of the radially outer surface of the radially outermost crown layer, vertically beneath the central part of the tread, is enough to register an improvement in dynamic performance under transverse load. The radial amplitude of this undulation needs to be at least equal to 1 mm in order to have significant effects on the scale of the tyre. Thus, in the invention, the difference between the radial distance (do) between the radially outer surface (ROS) of the radially outermost working layer and the tread surface is at least 1 mm less than the radial distance (dc) between the radially outer surface (ROS) of the radially outermost working layer and the tread surface, this being the distance vertically beneath the centre of the bottom face of the circumferential furrow closest to said undulation, and specifically over a surface representing at least 10% of said layer.

The optimal solution takes into account the characteristics of the tyre and possibly of the vehicle. Optimization may be effected depending on the directional nature of the tyre, on the asymmetry thereof, and on the camber angle of the mounted assemblies with respect to the vehicle.

Preferably, for the part of the crown reinforcement vertically beneath the central part of the tread, over at least 20%, preferably at least 30% and at most 85%, of the radially outer surface (ROS) of the radially outermost crown layer, the radial distance (do) between the radially outer surface (ROS) of the radially outermost crown layer and the tread surface is at least 1.5 mm, preferably 2 mm, less than the radial distance (dc) between the radially outer surface (ROS) of the radially outermost crown layer and the tread surface, this being the distance measured vertically beneath the radially innermost point of the bottom face (243) of the circumferential furrow closest to said central undulation at the point in question. The design parameters that make it possible to regulate the dynamic response under significant transverse load, namely load representing at least around 50% of the nominal tyre load, are:
the extent of the undulations of the radially outermost working layer, in the knowledge that the void ratio of the tread pattern, rarely lower than 15%, limits this extent to at most 85% (85%=100%−15%). The more extensive the undulation(s), the stiffer the tyre under transverse load, which is the primary effect of the undulations.
The radial amplitude of the undulation is at least equal to 1 mm, but limited to 5 mm because of the radii of curvature that have to be imparted to the crown layers.

A preferred solution is therefore that, over at least 20%, preferably at least 30% and at most 85%, of the radially outer surface (ROS) of the radially outermost working layer, the radial distance (do) between the radially outer surface (ROS) of the radially outermost working layer and the tread surface is at most 5 mm, preferably at most 3 mm, less than the radial distance (dc) between the radially outer surface (ROS) of the radially outermost working layer and the tread surface, this being the distance vertically beneath the centre of the bottom face of the circumferential groove closest to said undulation.

For optimum performance in terms of puncturing and attack of the crown, without penalizing the rolling resistance, the radial distance (d1) between the radially outer surface (ROS) of the radially outermost working layer and the bottom face of the circumferential furrows is at least equal to 0.5 mm and at most equal to 4 mm, preferably at least equal to 0.7 mm and at most equal to 2 mm. Below the lower limits, the tyre may prove too sensitive to attack. Above the upper limits, the rolling resistance of the tyre would be penalized.

It is advantageous for the tread, for example a circumferential furrow of the tread, to comprise at least one wear indicator, and for the minimum radial distance (do) between the radially outer surface (ROS) of the radially outermost layer of the crown reinforcement and the tread surface to be at least equal to the radial distance (df) between the tread surface and the radially outermost point of the wear indicator. Specifically, it is important for the user to be able to see that the tyre is worn, using the wear indicator, and to be able to do so before the reinforcing elements of the radially outermost layer of the crown reinforcement begin to appear on the tread surface.

Advantageously, the minimum radial distance (do) between the radially outer surface (ROS) of the radially outermost layer of the crown reinforcement and the tread surface is at most equal to the depth D of the closest circumferential furrow plus 2 mm and at least equal to the depth D of the closest circumferential furrow minus 2 mm, and preferably substantially equal to the depth D of the closest circumferential furrow. This solution allows ideal positioning of the radially outermost layer of reinforcing elements of the crown reinforcement and the tread surface. The minimum radial distance (do) between the radially outer surface (ROS) of the radially outermost layer of the crown reinforcement and the tread surface has to be measured over the radially outer portion of the crown reinforcement, and therefore at an undulation.

Preferably, the depth D of a circumferential furrow is at least equal to 5 mm and at most equal to 20 mm. Tread pattern depths of between 6 and 10 mm allow a good compromise between wearing and rolling-resistance performance aspects in many passenger vehicle tyres. Tread pattern depths of between 10 and 20 mm are attractive for the same compromises in tyres for vehicles that carry heavy loads. The invention is not limited to tyres for a particular use.

In cases in which the radially outermost layer of reinforcing elements is a hooping layer, it is advantageous for the radially outermost layer of reinforcing elements in the crown reinforcement to comprise reinforcing elements made of textile, preferably of the aliphatic polyamide, aromatic polyamide type, of a type involving a combination of aliphatic polyamide and aromatic polyamide, of polyethylene terephthalate or of rayon type, which are mutually parallel and form an angle B at most equal to 10°, in terms of absolute value, with the circumferential direction (XX′) of the tyre.

One preferred solution is for at least one filling rubber having a radial thickness at least equal to 0.3 mm to be positioned vertically beneath each central undulation of the radially outermost crown layer and preferably radially on the outside of the carcass layer, preferably radially on the inside of the radially innermost working layer. The purpose of this is to allow the plies to undulate during building and curing. These filling rubbers may be present around the entire circumference of the tyre or be disposed in certain portions of the tyre, as required. It is possible to lay several filling rubbers vertically beneath the one or more undulations at different radius values having different properties depending on the tyre specification sheet. If just one filling rubber is laid, its maximum thickness is approximately equal, for a given undulation, to the radial amplitude of said undulation.

The invention is not particularly well-suited to tyres configured for use in distended mode, namely that can be used with a tyre internal pressure of below 1 bar. This is because such tyres are provided with an inner liner of variable thickness, with a high inner liner thickness in the sidewall and in the axially outermost point of the tyre. This additional thickness makes the sidewalls radially stiffer but at the expense of the rolling resistance, this not being the objective of the invention. The tyres according to the invention preferably have inner liners with a thickness at most equal to 1.5 mm. Another feature of these tyres according to the invention is that they have a thickness that varies by at most 30% from one bead to the other.

Tyres in which a part of the carcass layer vertically beneath the central part of the crown is radially on the inside of the points of the carcass layer vertically beneath the end of the radially innermost crown layer are not very compatible with the invention. Such crowns exhibit undulations in all of the crown and carcass layers, but with a radial amplitude that is greater than those of the invention, and for aquaplaning or some other purpose. This type of configuration does not meet the geometric definitions of the invention or address the same technical problem.

With the tread being made up of a rubber compound, it is advantageous for the filling rubber, laid vertically beneath the undulation(s), to be a rubber compound that has a dynamic loss tan δ1, measured at a temperature of 10° C. and under a stress of 0.7 MPa at 10 Hz, at most equal to and preferably 30% less than the dynamic loss tan δ2 of the rubber material(s) of which the tread is made, measured at a temperature of 10° C. and under a stress of 0.7 MPa at 10 Hz. For a filling material with the same hysteresis, the improvement in rolling resistance is achieved only by the reduction in the shear stress loadings that this material experiences. Because the filling material does not experience the same stresses as the rubber material of which the tread is made, it is possible to modify its characteristics in order to improve the rolling resistance still further. A 30% drop in hysteresis leads to a significantly greater improvement for the invention.

It is preferable for the crown reinforcement to consist of 2 working plies of opposite angles and one hooping ply, as in numerous present-day crown architectures.

In order to measure the various geometric magnitudes, including the radial amplitudes of the undulations and the extent of the undulations, it is usual for those skilled in the art to take the measurements on sections of tyre that are taken in meridian planes, or a meridian section. In order to achieve greater precision, these measurements may be the mean of 4 measurements taken on 4 meridian planes situated 90° apart, the tyre sections being polished in order to reveal the interfaces between the various compounds that make up the tyre. Because the tyre is torus-shaped, the measurements of the extent of a surface of an undulation are equivalent to measurements of length on a meridian section. For example, a check will be made on a meridian section to ensure that, for 10% of the length of the radially outermost crown layer in the central part of the tread, the radial distance between the radially outer surface of the radially outermost crown layer and the tread surface at the undulation(s) is at least 1 mm less than the radial distance between the radially outer surface (ROS) of the radially outermost crown layer and the tread surface, this being the distance vertically beneath the bottom face of the circumferential furrow closest to the point in question on said surface.

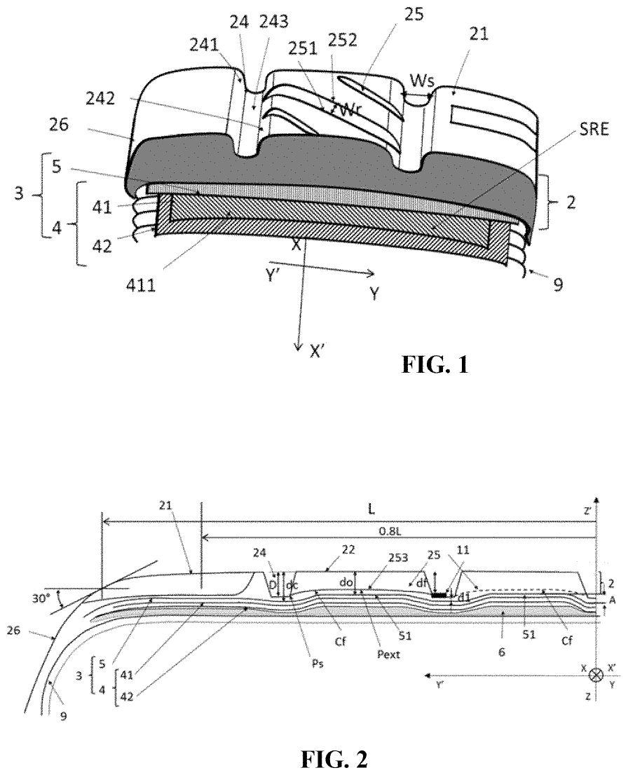

The features and other advantages of the invention will be understood better with the aid of FIGS. 1 to 7, said figures not being drawn to scale but in a simplified manner so as to make it easier to understand the invention:

FIG. 1 shows a crown portion of the tyre, the crown layers and the tread thereof,

FIG. 2 shows a meridian half-section through the crown of a tyre according to the invention provided with open grooves (25) which are radially on the outside of undulations and the bottom profile Cf of which is adapted to the undulation. It illustrates the radial amplitude A of an undulation (51) of the radially outermost crown layer 5, the various radial distances do, d1, D, df, dc, and a filling material (6) suitable for creating an undulation in particular of the radially outermost crown layer,

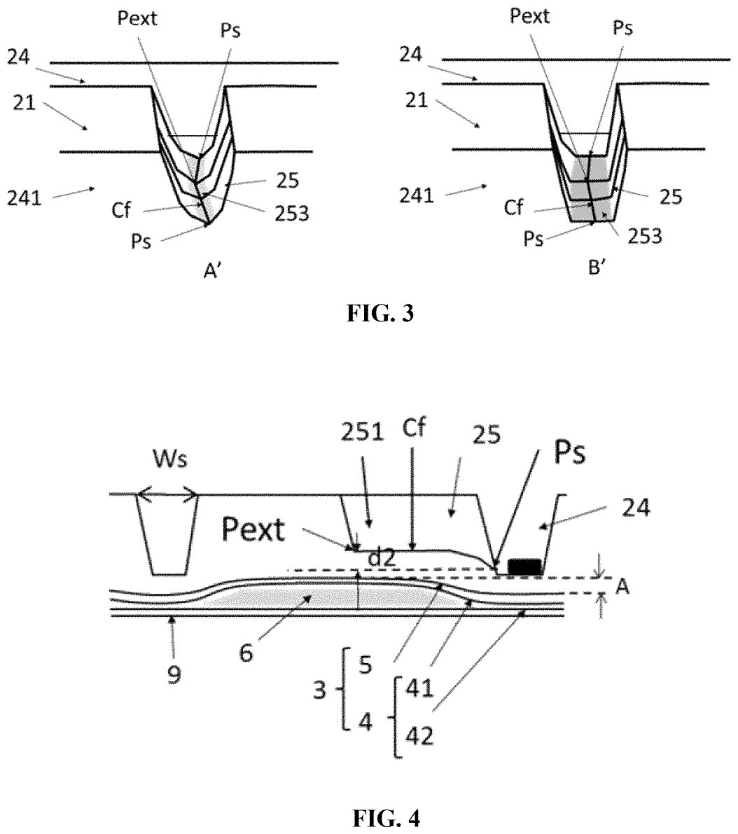

FIG. 3 shows open grooves 25, the bottom surfaces and bottom curves, or talweg Cf, thereof, and the intersection points Ps with the circumferential furrows (24) and the radially outermost point Pext of the bottom curve Cf,

FIGS. 4, 5 and 6 show a portion of a meridian section through the central part 22 of the tread and the part of the crown vertically therebeneath. These figures show variants in the position of the filling material (6) in the crown layers (41, 42, 5) and variants of open grooves (25) adapted to the undulation (51) which they are radially on the outside of.

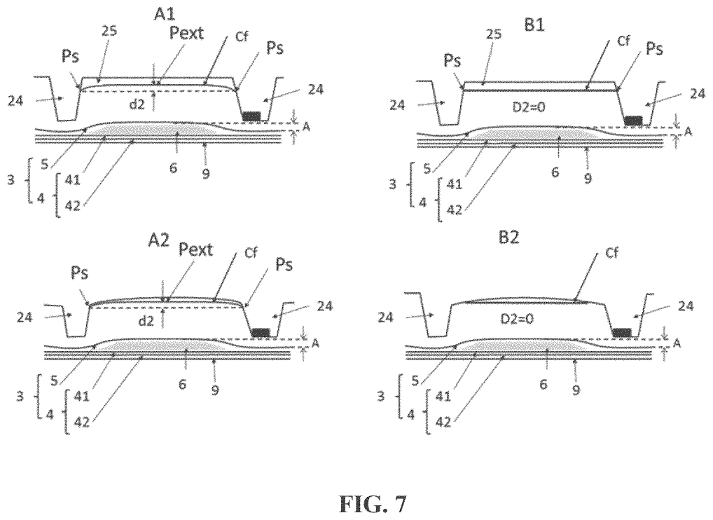

FIG. 7 shows a portion of a meridian section through the central part 22 of the tread and the part of the crown vertically therebeneath, in which there is located an undulation according to the invention A1 and according to the prior art B1 in the new state and in a worn state, A2 and B2, respectively, showing the effect of wear on the two variants.

A meridian section through the tyre is obtained by cutting the tyre on two meridian planes. This section is used to determine the various radial distances, the centre of the bottom faces of the grooves and of the furrows.

FIG. 1 shows a portion of the crown of a tyre. It shows a carcass layer 9, radially on the inside of the crown layer 3, comprising a working reinforcement 4 containing, in this instance, two working layers 41 and 42 made up of reinforcing elements 411 which are at least partially made of metal coated in an elastomer material, are mutually parallel and form with the circumferential direction (XX′) of the tyre an oriented angle of which the absolute value is at least equal to 15° and at most equal to 50°, and a hooping layer 5. The tyre also comprises a tread 2, which is delimited by the tread surface 21 and the outer lateral surfaces 26 and comprises cuts, in this instance two circumferential furrows 24 having widths Ws at least equal to 5 mm and grooves 25 having widths Wr at least equal to 0.5 mm. The circumferential furrows 24 comprise two lateral faces 241 and 242 and a bottom surface 243. FIG. 1 also shows a groove 25 opening into two circumferential furrows 24 and surrounded by two blind grooves 25 opening into one furrow. The grooves comprise lateral faces 251 and 252 and a bottom face 253 that is not shown in FIG. 1. The portions of the circumferential furrows shown in FIG. 1 in this case form a zero angle with the direction XX′; a circumferential furrow could be made up of a series of cuts that exhibit a non-zero angle with the direction XX′ and are connected to one another so as to form a continuous cut around the entire circumference of the tyre.

In FIGS. 2, 4, 5, 6 and 7, for reasons of ease of depiction, the grooves are shown as belonging to the meridian plane, but the grooves may have any of the forms known from the prior art, both in terms of angles and of shapes: simple, undulating, complex, with or without variations in thickness.

FIG. 2 schematically shows a meridian half-section through the crown of the tyre according to the invention. It illustrates in particular undulations of all the layers of the crown reinforcement (3), including the working layers (41, 42) and the radially outermost crown layer (5) with the aid of a filling material (6) positioned between the carcass layer (9) and the radially innermost working layer (42). This filling material causes all of the crown layers 41, 42, 5 to undulate and therefore creates an undulation 51 in the radially outermost hooping layer 5 of the crown layers.

FIG. 2 shows how the width L of the tread is determined. The width L of the tread is determined on a tyre mounted on a nominal rim and inflated to the nominal pressure. In the event of an obvious boundary between the tread surface and the rest of the tyre, the width of the tread is determined by a person skilled in the art in a trivial manner. If the tread surface 21 is continuous with the outer lateral surface 26 of the tyre, the axial limit of the tread passes through the point at which the angle between the tangent to the tread surface 21 and an axial direction YY′ is equal to 30°. When, in a meridian plane, there are several points for which said angle is equal to 30°, it is the radially outermost point that is adopted. The width of the tread is equal to the axial distance between the two axial limits of the tread surface on either side of the equatorial plane.

FIG. 2 also illustrates the following radial distances:
D: the depth of a circumferential furrow (24), this being the maximum radial distance between the tread surface (21) and the bottom face (243) of the furrow (not including retreading wells),
dc: the radial distance between the radially outer surface (ROS) of the radially outermost crown layer (5) and the tread surface (21), this being the distance vertically beneath the radially innermost point of the bottom face (243) of the circumferential furrow (24),
do: the radial distance between the radially outer surface (ROS) of the radially outermost crown layer (5) and the tread surface (21) at the undulation (51),
d1: the minimum radial distance (d1) between the radially outer surface (ROS) of the radially outermost crown layer (5) of the crown reinforcement (3) and the bottom face (243) of the circumferential furrows (24),
df: the radial distance between the tread surface (21) and the radially outermost point of the wear indicator (11),
A: the radial amplitude of the undulation measured for a given undulation between the radially outermost point of said undulation and the radially innermost point of said point situated vertically beneath the closest circumferential furrow 24.

FIG. 2 shows two undulations 51 of the radially outermost crown layer in the central part 22 of the tyre, which is centred on the equatorial plane and has a width equal to 0.8*L. Each of these undulations is radially on the inside of open grooves 25, the bottom curve Cf of the bottom surface 253 of which is adapted to the undulation. The bottom curve Cf is adapted inasmuch as the intersection points Ps of the bottom curve and of the lateral walls 241, 242 of the circumferential furrows 24 into which the grooves 25 open are radially on the inside of a point Pext, which is the radially outermost point of the bottom curve Cf, and such that the radial distance d2 between Pext and both of the points Ps is at least equal to one third of the radial amplitude of the undulation in question, the radial amplitudes of the undulations being able to vary from one rib to another. Moreover, the bottom curve increases radially from the points Ps to the point Pext.

FIG. 3 shows two grooves opening into two furrows 24. Of the first furrow in the foreground, all that is sketched is the lateral face 241. In Figure A′, there is a single bottom curve or talweg of the bottom surface 253, and it can be easily determined. The curve of intersection of the lateral face 241 of the circumferential furrow and of the bottom surface 253 of the groove is determined and its radially innermost point Ps, which is the starting point of the bottom curve, is determined. Similarly, the other end of the bottom curve Cf is determined either by following the same procedure with the other furrow or by finding the curve of intersection between the bottom surface 253 and the surface closing the groove in the case of a blind groove. Next, by intersection of the circumferential planes contained between the ends of the curve Cf with the bottom surface 253, the set of points forming the bottom curve Cf is determined. In FIG. 3 B′, there is not just one curve Cf and in this case a mean curve Cf made up of the most equidistant points from the lateral faces 251, 252 of the groove 25 in question from the possible intersection points PS with the circumferential furrow(s) is considered. Next, the same procedure is followed with the curves brought about by the intersection of the circumferential planes and the bottom surface 253 in order to determine the rest of Cf. A person skilled in the art knows how to determine the bottom curve of a groove without difficulty.

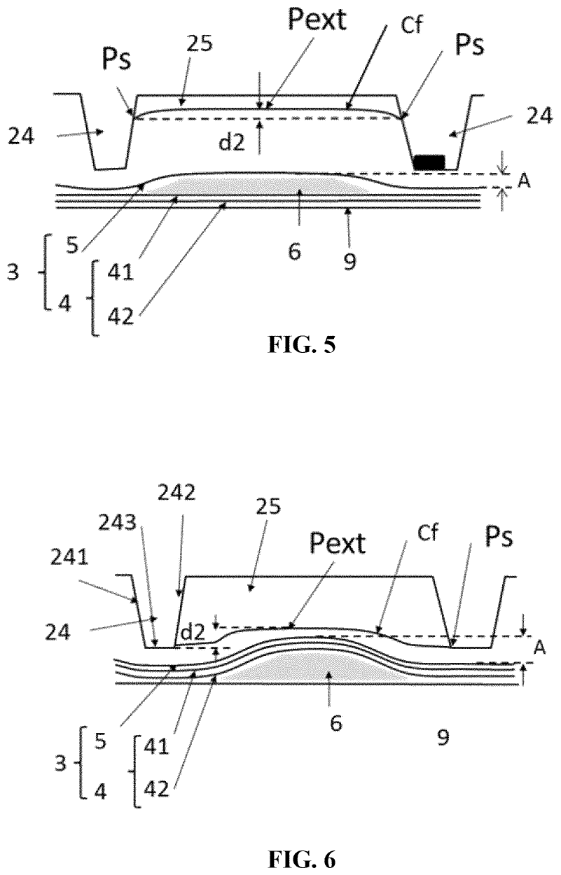

FIGS. 4, 5 and 6 show variants of possible positions of the filling material 6 in the crown 3:
Between the carcass layer 9 and the radially innermost working layer, as illustrated in FIG. 6,
Between the working layers 41 and 42, as illustrated in FIG. 4,
Between the radially outermost working layer 41 and the radially outermost crown layer 5, as illustrated in FIG. 5.
It is possible to conceive of several filling materials positioned in the different positions illustrated here, with suitable thicknesses for obtaining undulations with a desired radial amplitude.

FIG. 4 shows a blind groove 25, which thus opens into a single circumferential furrow (24).

FIG. 5 shows that the grooves 25 can have a shallow depth, less than 2 mm.

FIG. 6 shows a bottom curve with several levels of curves. It is possible to have rectilinear bottom curves or bottom curves that are rectilinear in a piecewise manner.

FIG. 7 shows a rib of the tread radially on the outside of an undulation 6, comprising a groove 25 opening into two circumferential furrows 24 on either side of the rib and the bottom curve Cf of said groove. For Figure A1, according to the invention, Cf is adapted to the undulation. For Figure B1, according to the prior art, Cf is not adapted to the undulation of the radially outermost crown layer vertically beneath the rib. Figures A2 and B2 show the ribs A1 and B1, respectively, after wearing down. On account of the undulation, the ribs will exhibit more pronounced wear at the cliffs of the circumferential furrows. Under the effect of the pressure, the working layers will become taut and the undulation will lose radial amplitude A and the centre of the rib will hollow out with respect to the cliffs of the furrows, creating a wear pattern that is more accentuated at this location. For a bottom curve Cf that is not adapted, the groove will disappear at the cliffs of the ribs, as in diagram B2. In the contact patch, this groove, which is not disposed over the entire width of the rib, will trap air, generating noise on leaving the contact patch. With an adapted bottom curve, the groove remains open and the level of noise does not worsen.

The invention was implemented on a tyre A of size 295/35 ZR20 intended to equip a passenger vehicle. The depths D of the circumferential furrows in the tread pattern are equal to 7.5 mm, for widths Ws that vary in the vicinity of 4 mm. The crown reinforcement is made up of two working layers, the reinforcing elements of which make an angle of + or −38 with the circumferential direction, and of a hooping layer, the reinforcing elements of which make an angle of + or −3 with the circumferential direction. The reinforcing elements of the working layer are continuous metal cords. The radially outermost crown layer is undulating such that 50% of its radially outer surface (ROS) is at least 1 mm radially further out compared with this same surface vertically beneath the closest circumferential furrows. The undulations have radial amplitudes of 2 mm. The radial distance (d1) between the radially outer surface (ROS) of the radially outermost working layer (41) and the bottom face (243) of the circumferential furrows (24) is equal to 1.6 mm. The tread pattern has 4 circumferential furrows and 4 ribs in the central part 22 of the tread. Each rib of the central part 22 is radially on the outside of an undulation 51 of the crown layers 41, 42, 5. The ribs comprise grooves 25 that open into the circumferential furrows 24 with a depth of 3 mm and are spaced apart from one another by a mean spacing equal to 30 mm. The bottom curves of the grooves are all adapted to the undulations of the crown layers 5, 41, 42. The distance d2 between the intersection points Ps of the bottom curve and of the circumferential furrows and the radially outermost point Pext of the bottom curve of the grooves is at least equal to 0.7 mm. The bottom curves increase radially from the points Ps and Pext.

The tyres A were compared with tyres B of the same size, having the same characteristics except that the bottom curves of the grooves in the central ribs are not adapted to the undulations of the crown layers, the bottom curves of the grooves being on one and the same radius, from one furrow to another.

The tyres were tested for noise in the new state in accordance with the European standard in force. No difference in performance was measured. The tyres were then worn down on the open road under the same running conditions, using the same types of vehicles, at the same speeds. After 1.7 mm of wear, the majority of the grooves for the tyre A according to the invention and the tyre B according to the prior art exhibit greater wear at the cliffs of the ribs than at their centres. In the tyre A according to the invention, the majority of the grooves, on account of the bottom curve Cf being adapted to the presence of the undulations of the crown layers, remain open. For the tyre B, the grooves were worn down at the cliffs such that the ends of the grooves, in their worn form, are located at the top of the rib. A coast-by noise test of these two tyres shows that the performance of the tyre A is better than the performance of the tyre B by around 0.7 dB under a test protocol according to the European directive 2001_43_CE in force.

1.-10. (canceled)

11. A tire comprising:
a tread intended to come into contact with a ground via a tread surface having an axial width L and comprising a central part of the tread having a width equal to 0.8*L, the central part of the tread comprising at least two circumferential furrows,
each circumferential furrow forming a space that opens onto the tread surface around an entire circumference of the tire and being delimited by two main lateral faces connected by a bottom face, and having a mean width Ws at least equal to 6 mm and a depth D at least equal to 4 mm,
the central part of the tread comprising grooves forming a space that opens onto the tread surface, forming an angle at least equal to 15° with a circumferential axis, and being delimited by two main lateral faces connected by a bottom face, a groove having a width Wr defined by a mean distance between the two lateral faces, and having a width Wr at least equal to 0.5 mm, at least fifty percent of the grooves being open grooves that open into one or two circumferential furrows, and
each open groove comprising a bottom curve Cf formed by all of the radially innermost points of the bottom surface of the groove, each bottom curve comprising at least one point Ps, and at most two, in common with the furrow or the two furrows into which the groove opens, and a radially outermost point Pext;
a carcass layer and a crown reinforcement, radially on the inside of the tread, comprising at least one crown layer, the crown layer being a layer of reinforcing elements,
the crown reinforcement comprising a working reinforcement comprising at least one working layer,
each working layer comprising reinforcing elements which are at least partially made of metal coated in an elastomer material, are mutually parallel and form with the circumferential direction of the tire an oriented angle of which the absolute value is at least equal to 15° and at most equal to 50°,
each crown layer extending radially from a radially inner surface to a radially outer surface,
the radially outermost crown layer vertically beneath the central part of the tread comprising at least one central undulation with a radial amplitude A,
the portion of the radially outer surface of the crown layer of the central undulation is radially on the outside of the points of the radially outermost crown layer vertically beneath the bottom face of the circumferential furrow closest to the central undulation,
over at least 10% of the radially outer surface of the crown layer vertically beneath the central part of the tread, a radial distance between the radially outer surface of the radially outermost crown layer and the tread surface at the central undulation is at least 1 mm less than a radial distance between the radially outer surface of the radially outermost crown layer and the tread surface, this being the distance vertically beneath the bottom face of the circumferential furrow closest to the point in question on the surface, and
the radial distance between the radially outer surface of the radially outermost crown layer and the bottom face of the circumferential furrows is at most equal to 4 mm,
wherein at least 50% of the open grooves radially on the outside of the central undulation of the radially outermost layer of reinforcing elements are adapted to the central undulation,
wherein an open groove that is adapted to the undulation which it is radially on the outside of being such that the intersection point Ps of the bottom curve Cf of the open groove adapted to the undulation and of the circumferential furrow into which the open groove adapted to the undulation opens are at a distance from the radially outermost point Pext of the bottom curve Cf by a radial distance at least equal to one third of the radial amplitude of the central undulation situated vertically beneath the open groove adapted to the undulation, and
wherein the curve Cf increases radially from the intersection point Ps to the point Pext.

12. The tire according to claim 11, wherein an open groove adapted to the central undulation of the radially outermost crown layer which it is radially on the outside of is such that the radial distance between the intersection point Ps of the bottom curve Cf of the open groove and of the circumferential furrow into which the open groove opens and the radially outermost point Pext of the bottom curve Cf is at least equal to half the radial amplitude of the central undulation situated vertically beneath the open groove and at most equal to 1.5 times the radial amplitude of the central undulation situated vertically beneath the open groove.

13. The tire according to claim 11, wherein all the crown layers have central undulations, and the central undulations are substantially identical in terms of position and of radial amplitude in the portions situated vertically beneath the central part of the tread.

14. The tire according to claim 11, wherein at least 90% of the open grooves radially on the outside of a central undulation of the radially outermost crown layer are adapted to the central undulation, which they are respectively radially on the outside of, of the radially outermost crown layer.

15. The tire according to claim 11, wherein, for the part of the crown reinforcement vertically beneath the central part of the tread, over at least 20% of the radially outer surface of the radially outermost crown layer, the radial distance between the radially outer surface of the radially outermost crown layer and the tread surface is at least 1.5 mm less than the radial distance between the radially outer surface of the radially outermost crown layer and the tread surface, this being the distance measured vertically beneath the radially innermost point of the bottom face of the circumferential furrow closest to the central undulation at the point in question.

16. The tire according to claim 11, wherein the radial distance between the radially outer surface of the radially outermost crown layer and the bottom face of the circumferential furrow is at least equal to 0.5 mm and at most equal to 3 mm.

17. The tire according to claim 11, further comprising at least one wear indicator, wherein the minimum radial distance between the radially outer surface of the radially outermost crown layer of the crown reinforcement and the tread surface is at least equal to the radial distance between the tread surface and the radially outermost point of the wear indicator.

18. The tire according to claim 11, wherein the minimum radial distance between the radially outer surface of the radially outermost crown layer of the crown reinforcement and the tread surface is at most equal to the depth D of the closest circumferential furrow plus 2 mm and at least equal to the depth D of the closest circumferential furrow minus 2 mm.

19. The tire according to claim 11, wherein at least one filling material having a radial thickness at least equal to 0.3 mm is positioned vertically beneath each central undulation of the radially outermost crown layer.

20. The tire according to claim 19, the tread being made up of at least one rubber compound, wherein the filling material is a rubber compound having a dynamic loss tan δ1, measured at a temperature of 10° C. and under a stress of 0.7 MPa at 10 Hz, at most equal to the dynamic loss tan δ2 of the rubber material of which the tread is made, measured at a temperature of 10° C. and under a stress of 0.7 MPa at 10 Hz.
